(19) United States
(12) Patent Application Publication
(10) Pub. No.: US 2015/0006309 A1
(43) Pub. Date: Jan. 1, 2015

(54) Social Buyer Aggregation System and Method

(71) Applicant: Alfred Philipson, Austin, TX (US)

(72) Inventor: Alfred Philipson, Austin, TX (US)

(21) Appl. No.: 13/932,783

(22) Filed: Jul. 1, 2013

(51) Int. Cl. G06Q 30/06

(52) U.S. Cl. CPC G06Q 30/0605
USPC 705/26.2

(57) ABSTRACT

A method for operating a dynamic pricing system wherein the initial price of products and/or services (items) offered for sale decreases in pre-determined increments based on pre-determined quantities sold during the sale, allowing all buyers to purchase the item at the lowest price point reached by the disparate, aggregated group of buyers, thus providing incentive for buyers to entice additional buyers to purchase the item, driving the price of the item down to the lowest attainable level for all buyers while increasing sales at low cost for sellers.

### CROSS-REFERENCE TO RELATED APPLICATIONS

Not Applicable

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND OF THE INVENTION

The embodiments described herein relate generally to selling and procuring products and/or services via an electronic exchange system and method allowing sellers to liquidate inventory by aggregating buyers using a social framework, facilitating purchases using a declining price strategy based on quantities sold and known sale data such as item(s) for sale, initial price, quantities available for sale, the degree to which the price for all buyers engaged in the sale will decrease due to a per-determined quantity of items sold during the time allotted for the sale.

When wishing to liquidate inventory or gain market share, suppliers spend time, effort and money seeking a multitude of smaller buyers to purchase what in the aggregate, amounts to large quantities of inventory or services. Accordingly, it is desirable to provide them with a procurement method and system that aggregates the buyers in an automated fashion using social networks and related technology to attract buyers and bidders to an offering wherein the price of the item on offer declines in known increments based on the sale of known quantities. As the additional buyers buy and bidders make offers, the price declines for all buyers based on business rules during a known time frame.

Such a procurement platform allows retail consumers to buy at the lowest possible prices while sellers, often holding large quantities of inventory, can readily find a number of buyers in significant quantities to make purchases. Moreover, this system encourages buyers to bid in advance in order to buy at a low cost, yet provides them with the incentive of a lower cost if they alert others of the buying opportunity, thus adding more buyers and decreasing the price further for all buyers. The supplier benefits not only due to the inventory liquidation, but to the new customers that can be found via the viral nature of this electronic word-of-mouth provided by consumers to other consumers that trust them and value their opinions.

### BRIEF SUMMARY OF THE INVENTION

The following presents a simplified summary of the specification in order to provide a basic understanding of some aspects of the specification. This summary is not an extensive overview of the specification. It is intended to neither identify key or critical elements of the specification nor delineate the scope of the specification. Its sole purpose is to present some concepts of the specification in a simplified form as a prelude to the more detailed description that is presented later.

The method includes providing a platform for a seller to list a product or service available wherein the price for the product or service will be reduced as additional quantities are sold. The platform validates the sellers and the buyers. Once a seller lists the item(s) for sale, the quantities available, the preset permissible downward bidding increments based on the quantity sold and the time interval in which the sale will take place, buyers begin bidding.

Because the initial sales price is low, buyers will bid on the items, buying the item at the initial cost. In addition, buyers know the price offered for the good or service will be reduced in proportion to the quantities sold and will therefore alert other buyers to the bidding opportunity. The platform in turn continues to register and validate new buyers, receiving additional bids from some of them. As the price declines based on the increase in quantities sold, additional buyer interest may be created, adding more buyers which in turn decreases the price further, based on the preset permissible downward bidding increments, thus creating a virtuous cycle where both buyers and seller benefit. Moreover, the system provides a way for both sellers and buyers to win as the bidders don't bid against each other; they bid with each other, each having a vested interest in procuring large quantities of the sale item(s), which in turn benefits the seller.

The system and method tracks the declining price level and the quantities sold and adjusting the current price. Throughout the buying cycle, the System distributes price, quantity and time remaining information to registered buyers and others via known electronic means such as via social networks, RSS feeds, SMS, mobile application(s), affiliated web sites.

When the pre-determined timeline has run out, all qualified bidders are awarded the product or service at the price the aggregated buying group has achieved. All bidders are contractually liable to buy the offering at this price and most sellers will require payment at the time of the bid. In one embodiment, those buyers that placed their bids and made payment at a higher price earlier in the bidding cycle will receive a credit for any over payment, credited to the form of payment used to buy the item, i.e. credit card, ACH, etc. or buyers may choose to keep a positive balance on their account. In all embodiments, the system and method includes billing successful bidders, receiving payment from buyers, transmitting the payments to sellers, and serving as a mediation platform for buyer and seller discrepancies.

The system and method includes computer servers with database, application and front end coupled together via a communications network. A business rules engine in the system operates the business rules and pricing algorithms, implementing the parameters of the sale provided by the seller. Typical parameters include the quantity to be reached to achieve the subsequent price decrease, the time allowed for the sale, the number of units any one buyer may purchase, events that can be triggered to extend the time of the sale, the criteria for buyer award of the item and the downward price increments.

### BRIEF DESCRIPTION OF THE DRAWINGS

In the following description, for purposes of explanation, numerous specific details are set forth in order to provide a thorough understanding of the claimed subject matter. In other instances, well-known structures and devices are simply shown in block diagram form to facilitate describing the subject matter claimed.

FIG. 1 is a simplified block diagram of an exemplary ecosystem in which the system and method operates.

FIG. 2 is a simplified block diagram of an exemplary embodiment of a flow of activities carried out by the system.

FIG. 3 is a simplified block diagram of an exemplary embodiment of the method for sellers to set up the parameters of the sale.

FIG. 4 is a detailed flowchart illustrating the method for buyers to interact with the system.

FIG. 5 is a detailed flowchart illustrating an embodiment of the method and system.

FIG. 6 is a detailed flowchart illustrating an additional embodiment of the method and system.

FIG. 7 is a simplified block diagram illustrating the end of a sale using the system and method.

### DETAILED DESCRIPTION OF THE INVENTION

When wishing to liquidate inventory or gain market share, suppliers spend time, effort and money seeking a multitude of smaller buyers to purchase what in the aggregate, amounts to large quantities of inventory or services. Some known systems enable consumers to search for particular products or services, and to readily compare sale prices or bid prices, at times procuring these items via these systems. Moreover, some known systems enable consumers to purchase items at a discount by pre-paying for the item, receiving a voucher that can be used on or offline. Known offline systems allow customers to call a telephone number as the price for an item decreases on a television program, allowing a handful of random callers to purchase an item on offer at an arbitrarily declining price level during a pre-defined time interval.

Such systems do not aggregate potential bidders using distributed social networks, nor do they allow customers to form disparate but cooperative buying groups that accrue pricing power. Further, these systems do not allow customers to receive price decreases in known, pre-determined increments based on the quantities sold over a pre-determined time interval. Moreover, most, if not all known reverse auction systems award the best prices to one winner of an auction. Other systems offer incentive-based pricing on a first-come, first-served basis, allowing only one customer or a subset of customers to buy at the lowest price.

Accordingly, it is desirable to provide a system and method for a procurement platform wherein a declining price mechanism allows known sellers to provide the terms of the sale for products and/or services, descriptions of the item(s) on offer, the quantities available at each price point, initial and subsequent prices that are based on the aggregated buying group achieving pre-determined quantity thresholds wherein all customers buy at the lowest price level reached by the aggregated group of buyers.

Such a system and method allows retail consumers to buy at the lowest possible prices while sellers, often holding large quantities of inventory, can readily find a number of buyers in significant quantities to make wholesale purchases. Moreover, this system encourages buyers to pay in advance in order to buy at a low cost, yet provides them with the incentive of a lower cost if they alert others of the buying opportunity, thus adding more buyers and decreasing the price further for all buyers. The supplier also benefits; not only due to the inventory liquidation, but to the sometimes viral nature of this electronic word-of-mouth provided by consumers to those that trust and value their opinions via their social network, thus creating a virtuous cycle of benefits for all involved parties.

The claimed subject matter is now described with reference to the drawings. The figures drawn in simplified block diagrams are illustrations intended to provide any needed context to assist in understanding the detailed flow charts, which are directly related to the claims. To further assist in understanding, reference numerals are used in all diagrams to refer to like elements throughout. As used in this application, the terms “system” and “method” are generally intended to refer to a process to be carried out using a combination of hardware and software.

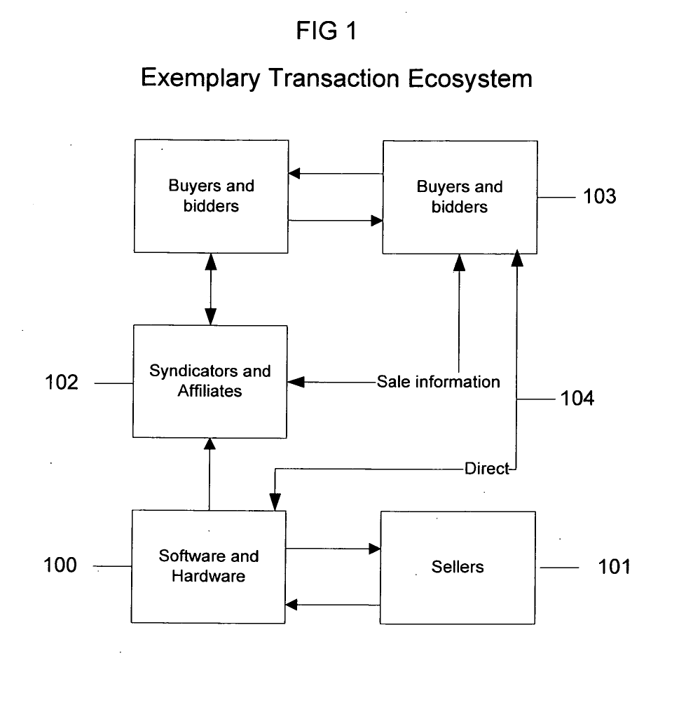

FIG. 1 is a simplified block diagram of an exemplary ecosystem comprised of a software and hardware enabling suppliers to list items and/or services for sale, validating buyers that bid on the listed items and processing their payment and shipping information. Software and hardware create a system (100) enabling sellers (101) to list items and/or services for sale and include descriptions of the items along with the sale parameters, or business rules, i.e. how long the sale will last, when it will begin and end, etc. The system in turn provides sale information to third parties such as sales affiliates and others that syndicate data for consumption by others (102) as well as to prospective buyers and bidders (103) directly through a variety of known means such as simple messaging system (sms), Rich Site Summary/Really Simple Syndication (RSS), widgets, mobile applications and email (104).

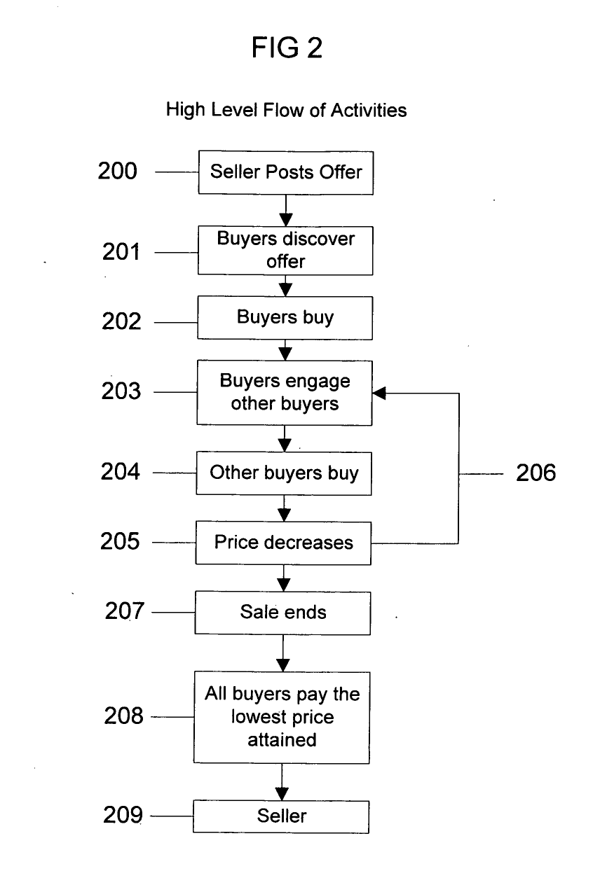

FIG. 2 is a simplified block diagram of an exemplary embodiment of a flow of activities carried out by the system. Seller posts the sale offering (200), buyers discover the sale offering (201), buyers buy (202), buyers engage other buyers (203) who may buy (204) so higher quantities are sold thus decreasing the price paid (205) for all buyers, creating a cycle of efforts (206) that lasts until the time allotted for the sale has reached the end (207). Once ended, all buyers receive the item offered at the lowest price attained by the aggregated buyers (208). The seller is notified (209), receiving the data needed to fulfill the orders.

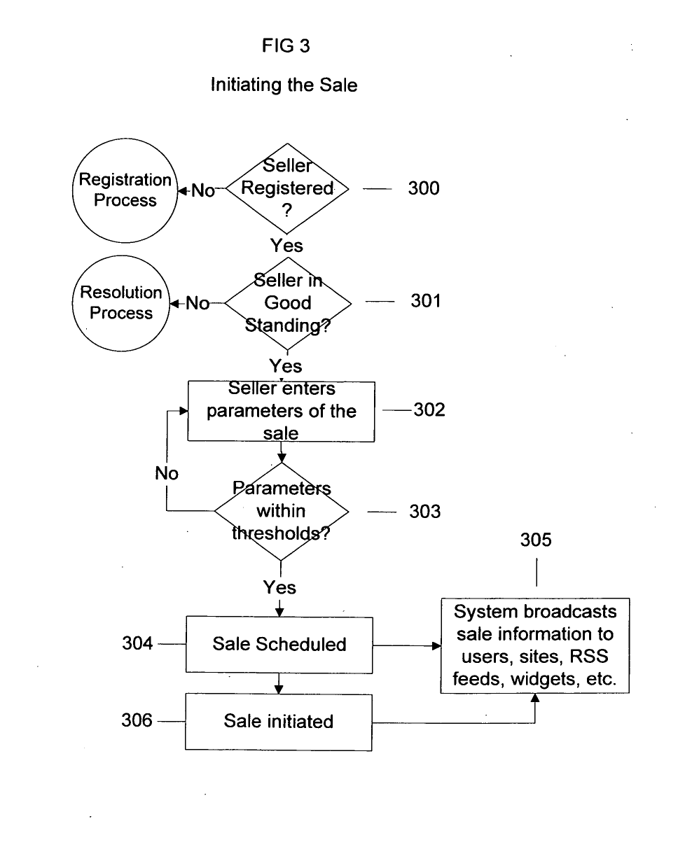

FIG. 3 is a simplified block diagram of an exemplary embodiment of the method for sellers to initiate the sale. Sellers verify their identity by logging in or they register if this is the first time using the system (300). If the seller is in good standing (301), they enter the parameters of the sale (302) such as the description of the item for sale, quantities available, the initial price and the price decreases that are based on the quantities sold, the time interval provided for buyers to buy, shipping costs and method, time frame for delivery. If these parameters are within the thresholds in the system (303), the sale is scheduled (304) and the sale information is broadcast to prospective buyers (305). Once the sale begins, (306) updated sale information is continually broadcast to prospective buyers.

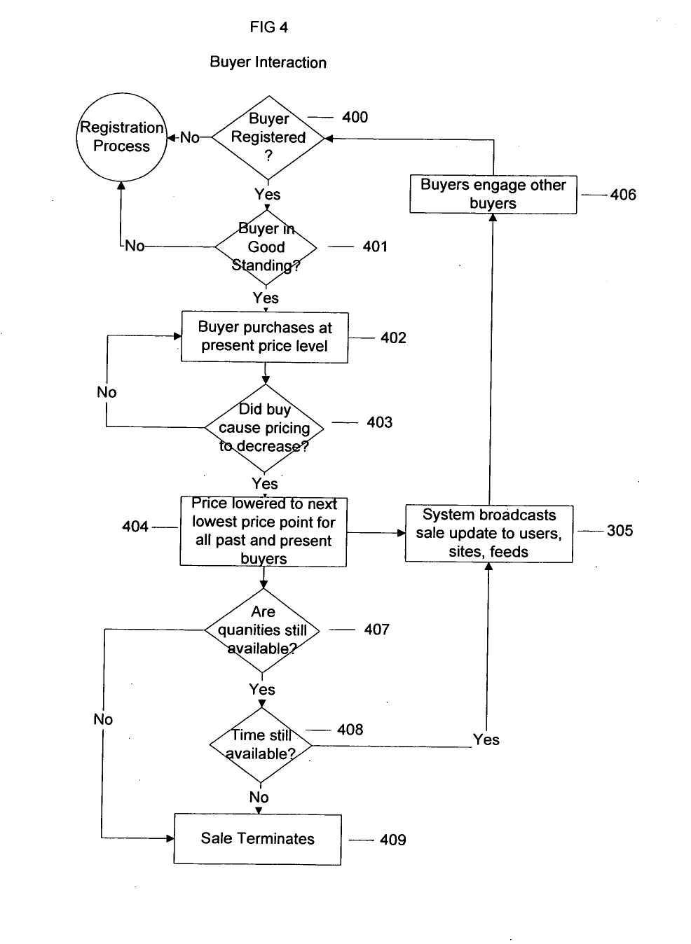

FIG. 4 is a detailed flowchart illustrating the method for buyers to interact with the system. Buyers register and are validated by the system (400). If the buyer is in good standing (401), the buyer may purchase the item on offer at the current price (402). If this purchase increases the quantity of items sold at a specified price point to a pre-determined threshold provided by the seller, the price is lowered to the next lowest price point for all buyers; those who bought earlier in the sale and those that bought later (404). The updated sale information is continuously broadcast to participants and prospective participants (305). Participants that discover the updated data may buy and/or may alert additional buyers to the opportunity (406), thus increasing the chance of all buyers meeting the quantity levels needed to continue to lower the price paid for all buyers. This cycle of buyers purchasing, alerting additional buyers to the sale, additional buyers making purchases that further increase quantities sold, lowering the price further based on known parameters continues until the quantities (407) or the time available for the sale (408) are depleted, terminating the sale (409).

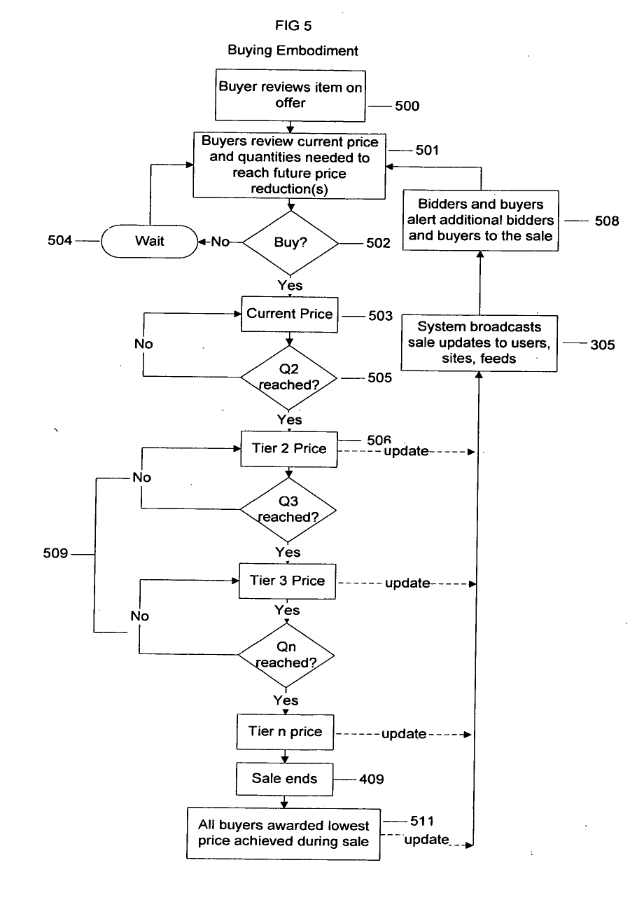

FIG. 5 is a detailed flowchart illustrating a buying embodiment of the method and system. Here, the prospective buyer reviews the item on offer (500), the current price and quantities needed to reach before any price reductions are initiated (501). Buyer decides whether to buy it or not (502). If the buyer decides to buy, the purchase is made at the current price (503). If the buyer doesn't choose to buy at the current price, the buyer may wait (504) until the price decreases due to other buyers that are willing to make the purchase. If the subsequent, pre-determined quantity of sales is reached (505), the price shall decrease to the subsequent, pre-determined lower level (506), and all buyers that bought earlier in the sale are awarded this lower price. The system broadcasts the lower price, the quantity level(s) needed to reach subsequent discounts and the time and quantities remaining available for the sale (305). Subsequently, bidders and buyers alert additional buyers to the buying opportunity so they can jointly achieve the lowest price possible (406). This cycle repeats, with the price of the item declining at a pre-determined rate based on the pre-determined quantities sold (509) until either the time for the sale has reached the end or the quantities available for sale have depleted (409). At sale end, all buyers receive the best price achieved by the aggregated buyers (511); any buyer that made a purchase at a higher price earlier in the sale process shall be credited the difference between the price paid previously and the price at the end of the sale.

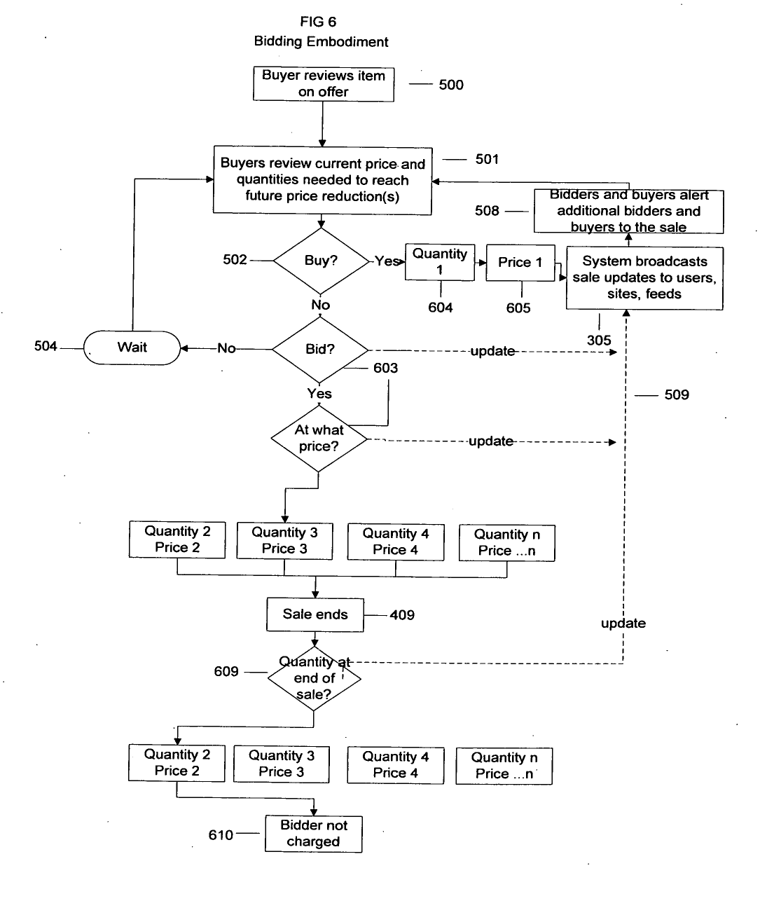

FIG. 6 is a detailed flowchart illustrating a bidding embodiment of the method and system. Here, the prospective buyer reviews the item on offer (500), the current price and quantities needed to reach before any price reductions are initiated (501). Buyer decides whether to buy at the current price (502) or to place a bid at one of the pre-determined lower price points that may be reached if a sufficient quantity of the item is sold during the time allotted for the sale (603). If the buyer does decide to buy (502), the purchase is made at the current price (502) which is based on the current quantity sold from inception of the sale (604). If buyer decides to wait (504), the purchase can be made at a later time during the sale. The system continually broadcasts the sale information through the network of affiliated web sites and subscribers via widgets, mobile, sms, social networks, etc. alerting parties of interest of the sale information (305). Prospective buyers that discover the sale information may make purchases at the current price, wait or place bid(s) at anticipated future price points (603). Because the price declines based on quantities sold during the time allotted for the sale, bidders and buyers alert additional customers to the buying opportunity to achieve the lowest price possible (508). This cycle repeats (509), with the price of the item declining at a pre-determined rate based on the pre-determined quantities sold until the time for the sale has reached the end or the quantities available for sale have depleted (409). At sale end, all buyers that bought at the current price will receive the best price attained by the aggregated buyers (609). Those bidders that placed a bid at a future price point wherein the quantities needed to reach that price point were attained by the aggregated buying group shall receive this best price. If the price did not decline to the bid price during the sale, the bidder will not receive the item or be charged for it (610).

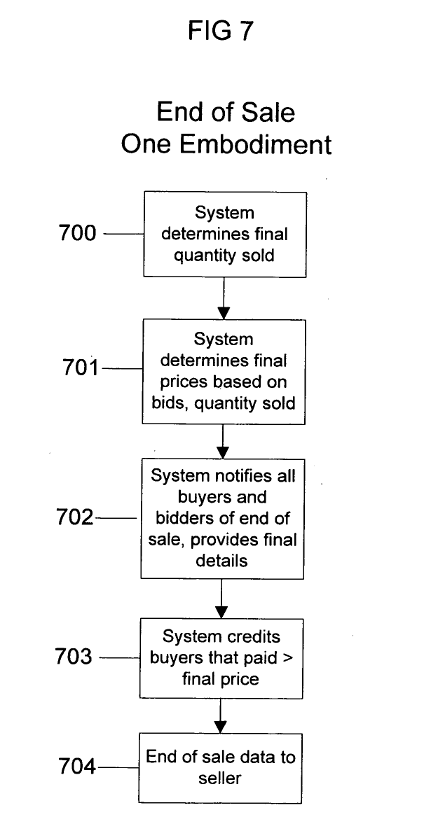

FIG. 7 is a simplified block diagram illustrating the end of a sale process at a high level using the system and method. The system determines final quantity sold (700) and the final prices based on quantity sold (701). The System notifies all buyers of the end of the sale, provides final details (305). System credits buyers that paid more than the final price if applicable (703) and sends data to sellers who fulfill their obligations to the buyers (704).

1. A method for operating a dynamic pricing system wherein the initial price of products and/or services (items) offered for sale decreases in pre-determined increments based on pre-determined quantities sold; during the time allotted for the sale; allowing all buyers to purchase the item at the lowest price point reached by the disparate, aggregated group of buyers; providing incentive for buyers to entice additional buyers to purchase the item during the sale; driving the price of the item down to the lowest attainable level for all buyers; while increasing sales at a low cost for sellers.

2. A method in accordance with claim 1, wherein a buyer doesn't buy the item at the current price; nor wait until the price decreases due to other buyers making purchases; and instead places a bid(s) on the item at an anticipated future price level; attaining that price (or lower); if the aggregated buying group achieves this bid price during the time allotted for the sale; and is not awarded the item if the price does not reach the bid price during the sale.

3. A method in accordance with claim 1, wherein the sale information consisting of item description, current price, quantity level(s) needed to reach subsequent decreases in price, the time and quantities remaining available for the sale; are broadcast via a number of known electronic means such as SMS, RSS, widgets, applications, web sites and ad placements; to alert prospective buyers to the buying opportunity; presenting transparency of pricing and inventory and bids at each price level; and providing recipients of said information an incentive to use their social networks to promote the item on sale; thereby increasing the reach of the seller beyond many traditional advertising methods; at a lower cost; due to the trust placed on one member of a social network on another.

4. A method in accordance with claim 1, wherein the cycle of buyers buying or bidding alert additional buyers to the buying opportunity repeats; with the price of the item declining at a pre-determined rate; based on the pre-determined quantities sold; until the time for the sale has reached an end; or the quantities available for sale have depleted; providing all participating buyers with the best price achieved by the aggregated buyers; crediting buyers that made purchases at a higher price earlier in the sale process; and awarding bidders with the item; if their bids were placed at a price level that was achieved during the time allotted for the sale.
